(19) United States
(12) Patent Application Publication
(10) Pub. No.: US 2022/0183315 A1
(43) Pub. Date: Jun. 16, 2022

(54) Insulating Device for Frozen Confections

(71) Applicants: Lucia Dzimkova, Ottawa (CA); Pascal Luc Roy, Ottawa (CA); Brenna Shengmei Morgan, Ottawa (CA)

(72) Inventors: Lucia Dzimkova, Ottawa (CA); Pascal Luc Roy, Ottawa (CA); Brenna Shengmei Morgan, Ottawa (CA)

(21) Appl. No.: 17/119,244

(22) Filed: Dec. 11, 2020

(51) Int. Cl. A23G 9/22; B65D 85/78; B65D 81/38

(52) U.S. Cl. CPC A23G 9/22; B65D 81/38; B65D 85/78

(57) ABSTRACT

The disclosed invention is an insulating device to protect frozen confections and is supported by a receptacle, for example an ice cream cone. The device includes a dome portion, a clamp, and a clamp attachment. The dome portion comprises a concave portion that faces the frozen confection held in the receptacle, to which the insulating device is clamped. The clamp attachment attaches the clamp to the dome portion and comprises a ball-and-socket rotatable joint. The clamp holds the cone by attaching near the rim of the cone, and comprises sturdy, adjustable material such as metal. Embodiments contemplate varying the dome portion size, malleability of the clamp, or both from device to device, to accommodate various cone sizes and various volumes of frozen confection.

### TECHNICAL FIELD OF THE INVENTION

The present invention relates generally to single-use and multi-use devices for frozen confections and more particularly to insulating devices that reduce melting of frozen confections held within ice cream cones.

### BACKGROUND OF THE INVENTION

On a hot summer day, frozen confections are a popular treat. The United States is the second largest global ice cream consumer, its per capita consumption rate being 20.8 litres per year. Specific locations such as Long Beach California, Austin Tex., and Philadelphia have the highest consumption rates in the country. During summer months, temperatures average around 30 degrees Celsius. There is a positive correlation between warm weather and ice cream consumption, which increases the consumer pain of dealing with melting of ice cream on warm days. The melting of ice cream is not only an issue in the United States, but globally as well, in countries such as New Zealand, China, and Australia, which are the countries where ice cream is widely consumed. These countries similarly experience hot temperatures throughout many months of the year.

Globally, the ice cream market is expected to have a value of $97.3 billion by the year 2023. The variety of ice cream products created and sold is expanding in terms of types, flavours, and consistencies, for example sorbet and gelato. In addition to hard and soft ice cream, low-fat and lactose-free varieties have experienced a growth in popularity in the ice cream industry and provide an opportunity for market expansion and growth. The appeal for these frozen confections lies in having a cold, refreshing treat that may be consumed during warm months. These frozen treats are subject to melting at warm temperatures, creating an inconvenience for the consumer and detracting from enjoyment of the treat as well as refreshment.

When individuals obtain an ice cream cone, it rapidly begins to melt under the hot ambient temperatures of the environment. It is difficult for users to consume the frozen confection at a rate faster than that of the melting dessert, leaving consumers with a sticky mess. To reduce the mess, individuals may wrap the ice cream cone in a napkin sleeve, place the scoop in a bowl, or eat it indoors, all of which are drawbacks and inconveniences to the user experience of eating ice cream or other frozen confections.

### Technical Problem of the Prior Art

Inventions tackling the issue of melting ice cream have previously been disclosed in the prior art. Inventions disclosed in U.S. Pat. No. 8,153,177, assigned to Robert C. Sotile, and U.S. Pat. No. D793026, assigned to Len Berman, describe devices that use a rim to catch melted ice cream. Other inventions attempt to reduce the rate of melting ice cream by providing a cover for the frozen confection or an alternative method to consuming the treat.

A holder for an ice cream cone that fits average-shaped cones, including round-bottom and pointed-bottom ones, is disclosed in U.S. Pat. No. 8,153,177. This patent, assigned to Robert C. Sotile, discloses a device that completely surrounds the cone, comprising a round disk at the top opening that prevents melted ice cream from dripping onto a consumer's hands. This leaves the problem of the user having to eat the partially melted confection at a fast pace to prevent overflow over the rim. Furthermore, an ice cream cone with a built in edible rim which catches ice cream drippings is disclosed in U.S. Pat. No. D793026. This design patent was assigned to Len Berman. These cones run the same risks as the cone holders in that the drip gutter may overflow. Furthermore, this ornamental design contains return apertures in which the melted ice cream drains back into the cone, which may cause the cone to rapidly become soggy and possibly break, creating an even larger mess. Thus, there is a need for a device to prevent, reduce, and delay ice cream from melting in the first place, or to retard the rate of melting until said confection is consumed. This would allow the consumer to more thoroughly enjoy the frozen confection.

Similar inventions include devices that prevent melted ice cream from running down the outside of the cone. One such invention was assigned to Fred H. Helfrich Jr. and Thomas P. Madden and is disclosed in CA1125530. The device comprises a cone holder and lid, and implements another method of catching melting ice cream using the lid, which is a receptacle dish used to hold ice cream scoops if the consumer wishes to turn their cone into a sundae dish. This prevents ice cream from dripping down one's hand, as all drippings will be contained in the dish. Furthermore, the lid may be used as an insulator to prevent the ice cream from melting while transporting the cone. This invention, and specifically the dome-shaped lid, does not allow the consumer to eat the frozen confection while also shielding it from the sun and insulating it from the heat of outside temperatures. The multi-functional dome is useful in its ability to prevent the ice cream from creating a mess, however, it does not allow the user to eat the ice cream from a cone while simultaneously keeping the ice cream insulated, which detracts from the experience. Furthermore, this device is not reusable, which is harmful for the environment.

A reusable insulated ice cream dish has been developed by Zac Designs. This device is useful for transportation of ice cream on the go. The thick insulating material allows for ice cream to remain cold for many hours. However, this device does not shield the ice cream from the sun, so it is possible for the ice cream to melt while the consumer has the container open. Similar to the invention disclosed in CA1125530, this insulated ice cream dish does not allow the user to consume the ice cream easily from a cone receptacle while the ice cream remains insulated.

A device that insulates a frozen confection, to allow consumers to eat it at their desired pace, is desirable. An insulating device that allows the consumer easy access to the frozen confection and allows the consumer to move and rotate the insulating portion according to preference, such that consumption is convenient, is necessary.

### SUMMARY OF THE INVENTION

The invention seeks to alleviate the problem of a frozen confection held in a cone receptacle melting at a rapid rate in warm environments. The device provides a method for keeping frozen confections chilled by providing shade, as well as acting as a thermal insulator.

In the disclosed invention, a clamp comprising a material that is sturdy and malleable is used to secure the device to a receptacle such as a cone. There are many different types of cones including cake cones, waffle cones, and sugar cones. Typical diameters of cone receptacles, such as those sold at WebstaurantStore, range from 1½ inches to 3¼ inches. A common cone of classic conical shape has overall dimensions of 2% inches for the top diameter, 2% inches for the interior diameter, and 6 inches for the height. The clamp is adjustable with the ability to wrap around any type of cone securely. Secure fastening of the clamp to the receptacle is achieved by having malleable metal comprise the clamp, so that the user may adjust the diameter of the clamp according to their cone shape and size, by applying pressure to deform the clamp toward the receptacle. The malleable metal may be coated with a material comprising flexible plastic, for comfort and adhesion to the cone.

Another aspect of the current invention is a rotatable ball-and-socket joint that attaches the clamp to the insulating dome. The ball-and-socket joint may be rotated in all directions so as to not get in the way when a consumer eats the frozen confection. The rotatable joint is tight enough to remain in the position and orientation of the user's choosing. The ball-and-socket joint is an attachment region that provides a connection point between the dome portion and the clamp portion, with the dome portion extending out to a position adjacent to the clamp attachment.

Another aspect of the current invention is a dome portion comprising a material which may have a high R-value to ensure effective thermal insulation. The dome comprises an inner insulating layer and an outer layer. Additionally it may have an inner layer protecting the insulating material, which may comprise polyisocyanurate or plant-based aerogel materials.

### BRIEF DESCRIPTION OF FIGURES

FIG. 1 illustrates an isometric view of the three functional components of the insulating device for frozen confections wherein the range of mobility of the ball and socket joint, as well as the different layers that make up the dome portion are shown.

FIG. 2 illustrates an isometric view of a single clamp portion on two different-sized cones depicting the flexibility and adaptiveness of the device to multiple types of receptacles for frozen confections.

FIG. 3 illustrates an orthographic view of the FIG. 1 insulated device mounted onto a cone-type receptacle containing a frozen confection.

### DETAILED DESCRIPTION OF FIGURES

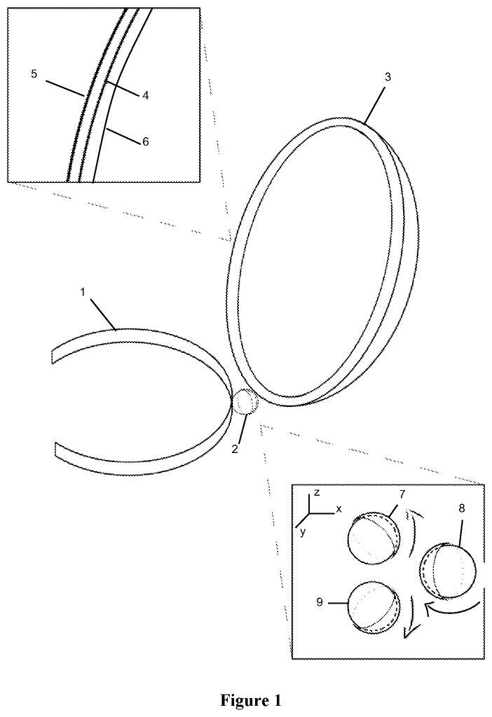

A representation of the present invention (FIG. 1 through 3) is described herein. This depiction of the invention's structure and configuration represents one alternative to the embodiments in which each part of the device may be expressed. The arrangement of the disclosed device may be similarly expressed or be expressed in an alternative way as to fit the needs of the user of the device. The present scale of the invention depicted in FIG. 1 through 3 was used to better visualise the functioning components of the device, but does not necessarily represent the true scale of said device. As such, all characteristics may have been rendered to a different comparable size as to better depict each functioning part or property of the invention. This does not limit the invention to the dimensions shown herein, as these dimensions are an example of the configuration in which the device may be constructed. In addition, the structural simplicity of the device, as depicted in the figures, is not a limiting factor regarding the structure of the invention. The insulating device for frozen confections may also have other applicable functions besides the ones disclosed.

Illustrated in FIG. 1 are the three components of the device: the clamp (1), the rotating joint clamp attachment (2) and the dome (3). The joint (2) consists of a full sphere, referred to as a ball, partially encapsulated with a similarly shaped structure that is larger at its base and gradually moves into a singular point at its maximum, referred to as a socket. The socket may be moved left and right in the horizontal x-axis (8), up and down in the vertical z-axis (7), as well as diagonally in the y-axis (9). This function enables the attached dome portion (3) to be moved out of the region where the frozen confection is being eaten. The socket is affixed to the dome portion (3) and the ball is affixed to the clamp (1), thereby linking the whole unit. The dome (3) is a partial hollow hemisphere that is wider at its base and gradually moves to a singular point at its maximum, referred to as the crown or apex of the dome portion. The dome (3) consists of three superimposed layers which may or may not be consumable. The outer layer (5) serves as the main protection from radiation and convection heat transfer. The middle layer (4) serves as the main protection from conduction heat transfer. The inner layer (6) serves as a protection for the middle layer (4) and separates it from the frozen confection. The clamp (1) is a ring-shaped structure that is sturdy, such that it maintains a stable grip on a frozen confection receptacle, but also malleable, such that it may be adjusted to variable sizes of common receptacles for frozen confections, which themselves may be consumable or not.

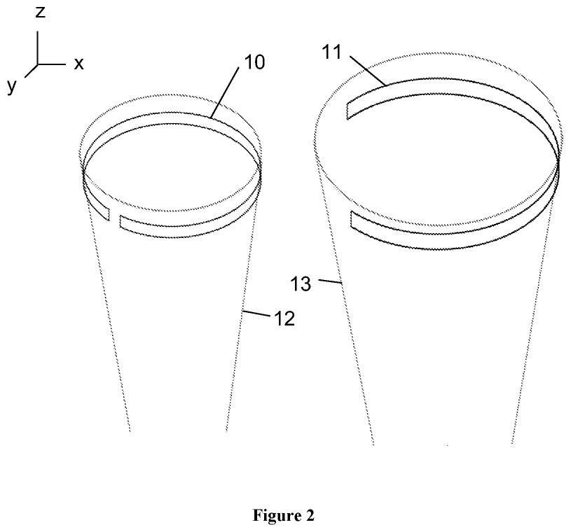

FIG. 2 shows the fitting of a single clamp (10, 11) on different size receptacles (12, 13). It is possible to observe a tighter fitting of the clamp (10) around a smaller (12), same cone-type receptacle as the larger receptacle (13), although the receptacle could be of different shape. The same clamp is shown in its expanded form (11) around the larger receptacle (13). The clamp (11) may be moved up or down along the receptacle (13) and may easily be adjusted by the user to accommodate the change in the receptacle size or perimeter (13), by applying pressure to the clamp to deform it, similarly to the tighter form (10) depicted in FIG. 2.

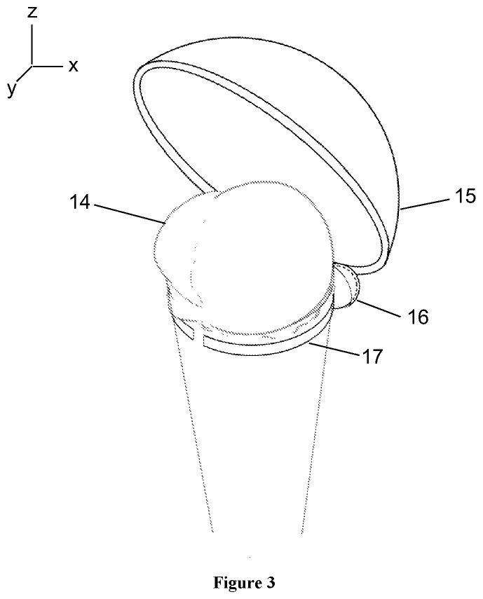

FIG. 3 shows the configuration of a complete insulating device (15, 16, 17) being mounted onto a receptacle containing a frozen confection (14). The dome portion (15) of the device may partially cover the frozen confection (14), or be moved closer to said confection (14) so that it may cover it completely. The dome (15) may be easily moved out of the vicinity of the frozen confection (14) that is being consumed, by way of the rotatable joint attachment (16) illustrated in FIG. 1, according to the consumer's preference. The entire device may also be easily moved down in the vertical z-axis direction as the receptacle is being consumed, in the case that the receptacle is edible, because the clamp (17) may easily be adjusted by applying deforming pressure to the malleable clamp (17) portion, to accommodate the size change of common receptacles.

With all this described, alterations to the preferred embodiment of the disclosed invention described herein may become evident to one skilled in the art. Any such modifications may be made without changing the scope of the general concept of the invention as defined by the disclosed claims.

What is claimed is:

1. A frozen confection insulating device, comprising:
a. a dome portion, wherein the dome portion is dome-shaped comprising a concave portion that faces the frozen confection held in a cone, to which the insulating device is clamped onto;
b. a clamp attachment, wherein the clamp attachment attaches the clamp to the dome portion and comprises a rotatable ball-and-socket joint;
c. a clamp, wherein the clamp holds the cone, and
d. the dome portion is attached to the clamp attachment, and
e. the clamp attachment is attached to the clamp.

2. The dome portion of claim 1 wherein the dome portion comprises a sturdy layer comprising, but not limited to, plastic or aluminum, an inner coating on the concave portion comprising lightweight insulating materials such as, but not limited to, polyisocyanurate and plant-based aerogel, and a final inner layer to protect the insulating material.

3. The dome portion of claim 1 wherein the dome-shaped portion comprises a circular base.

4. The dome portion of claim 1 wherein the dome-shaped portion may be symmetrical about a central axis extending from the crown or apex of the dome through the dome interior.

5. The dome portion of claim 4 wherein the dome-shaped portion has a surface at the crown or apex which extends radially and continues to the base of the dome of claim 3.

6. The clamp of claim 1 wherein the clamp comprises a sturdy, adjustable material such as, but not limited to, plastic or adjustable plastic-coated wire, such that the clamp may be deformed toward the receptacle by engagement with the clamp portion in use.

7. The clamp attachment of claim 1 wherein the clamp attachment provides a connection portion between the dome portion and the clamp portion.

8. The dome portion of claim 2 wherein the dome portion is not removable from the clamp attachment.

9. The clamp of claim 1 wherein the clamp is not removable from the clamp attachment.

10. The clamp of claim 1 spans 3 cm to 9 cm in diameter.

11. The dome portion of claim 1 spans 3 cm to 9 cm in diameter. The variable sizes of the dome portion may accommodate various volumes of frozen confection and various cone or receptacle sizes.

12. The insulating device of claim 1 wherein the insulating device is a multi-use device that may be washed, cleaned, and reused.
